(19) United States
(12) Patent Application Publication
(10) Pub. No.: US 2021/0378443 A1
(43) Pub. Date: Dec. 9, 2021

(54) METHOD FOR CONSERVING A MEAL PREPARED BY HEATING, AND FOR PROVIDING COMMUNAL CATERING

(71) Applicant: Z-CATERING MITTE GMBH, Berlin (DE)

(72) Inventors: Karsten Streeck, Berlin (DE); Jorg Streeck, Berlin (DE); Jan Andre Blum, Berlin (DE)

(73) Assignee: Z-CATERING MITTE GMBH, Berlin (DE)

(21) Appl. No.: 17/046,374

(22) PCT Filed: Apr. 10, 2019
(86) PCT No.: PCT/EP2019/059079

§ 371 Date: Oct. 9, 2020

(30) Foreign Application Priority Data
Apr. 10, 2018 (DE) 10 2018 108 437.4

(51) Int. Cl. A47J 36/24; A47J 27/18; A47J 36/32; A23L 3/36; A23L 3/10

(52) U.S. Cl. CPC A47J 36/2405; A47J 27/18; A23L 3/10; A47J 36/32; A23L 3/364; A47J 36/2483

(57) ABSTRACT

A method for the provision and conservation of communal meals is provided, in which a plurality of foodstuff and meal components are brought into packaging units and sealed therein following the preparation of said food by heating at a temperature of at least 75° C. A water bath at a temperature of less than 3° C. is used to cool the sealed packaging units in order to bring the meal component from a core temperature of 65° C. or higher to a core temperature of 3° C. or lower within no more than 90 min. Methods for regenerating the cooled packaging units for consumption are also provided, in a water bath having a temperature of 80°-90° C.

The invention relates to a method of providing and preserving communal meals, wherein a plurality of food meals or meal components are filled and sealed into packaging units after being prepared warm at a temperature of at least 75° C. A water bath having a temperature of less than 3° C. is used to cool the sealed packaging units to bring the food component from a core temperature of 65° C. or more to a core temperature of 3° C. or less within 90 min or less. In preferred embodiments, the invention further relates to methods for regenerating the refrigerated packaging units for consumption in a water bath having a temperature of 80°-90° C.

### BACKGROUND AND STATE OF THE ART

In the state of the art the Cook & Chill method is known, with which an immediate serving of food in communal catering can be dispensed with. The method differs from traditional warm catering methods in which the food is passed on to the end consumer immediately after preparation or kept warm until it is actually consumed. The latter methods are also known as Cook & Serve or Cook & Hold.

In contrast to Cook & Serve or Cook & Hold, Cook & Chill is characterized by a temporal decoupling of the production of food from its serving and thus a more flexible organization of preparation, without time pressure for a completion at serving time. In addition, the intermediate preservation enables an economic optimization with regard to the organization of the purchase, a central preparation in a large kitchen, if necessary, as well as a demand-oriented supply to decentralized end consumers.

In the well-known Cook & Chill processes, hot food components are first prepared and portioned in a conventional way and subsequently brought to a temperature in the range of 4 or 3 degrees Celsius within 90 minutes. The cooling method is called blast chilling, which is done with chilled air. The chilled communal food can be stored for up to four days, if the cold chain is unbroken. Immediately before serving, it is reheated to consumption temperature.

For this purpose, it is known in the state of the art to regenerate the menu components in catering containers or bain-marie containers by means of hot air systems. For this purpose, the hot air is blown directly onto the food at temperatures of 100° C., 150° C. or more.

One advantage of this procedure is that the microbiological contamination of the food can be minimized. One disadvantage, however, is that the air cooling and heating of the food by warm air in particular causes a clearly perceptible reduction in quality. This is reflected both in a change in the consistency of the food and in a loss of flavor.

Since food consumption in Germany has once again become more important, for example in a family setting, the cook & chill process according to the state of the art creates a large difference between the food that children find in the school cafeteria, for example, and the food they eat at home. Whereas in the family environment, attention is often paid to high-quality and good-tasting products, the quality of the food in the communal settings is severely compromised by the cook & chill method.

In the state of the art, there are various efforts to improve upon existing methods.

From WO 2007/1207025 a device for preserving cooked food is known, which comprises several containers and a heatable or coolable water bath. The containers are designed in such a way that an automatic closure ensures that the food does not come into direct contact with the water in order to prevent dilution. However, the implementation of the device is costly and unsuitable for transporting or storing a large number of food portions in communal catering.

In DE 44 14 814 C1, it is proposed that, when preparing food dishes, the cooking method be interrupted by cooling before a cooking point is reached. The food is subsequently packaged in separate portion packs for distribution to customers, where the cooking is finished in a decentralized 95° C. water bath. The cooling process takes place in a refrigerator. Therefore, only for small quantities of food, rapid cooling can be guaranteed. In addition, it is time-consuming to find the optimum pre-cooking point for different foods in order to match the pre-cooking process to the final cooking process.

U.S. Pat. No. 3,966,980 B2 discloses a method for preparing and preserving food, wherein the raw ingredients for a food dish are packaged in a plastic bag vacuum. The bags of raw ingredients are cooked in a water bath at temperatures up to 100° C. and then cooled to a low storage temperature. At the desired time of consumption, the food can be brought to a serving temperature by reheating in a water bath. While the method better preserves the flavor components of the prepared food, this is of limited use for communal catering or other catering services. In particular, only selected combinations of raw ingredients can be placed in the bag, which can be prepared at similar temperatures and cooking times. The flexibility required for communal meals in terms of food menus and ingredient combinations offered cannot be satisfactorily served.

### OBJECTIVE OF THE INVENTION

The objective of the invention was to provide a process which does not have the disadvantages of the prior art. In particular, a process should be provided which allows hot-prepared food to be stored in a durable manner while preserving the consistency, taste and nutritional content of the food as far as possible. Furthermore, the process should be characterized by simple handling and easy scalability, which distinguishes the process in particular for communal catering.

### SUMMARY OF THE INVENTION

The objective is solved by the features of the independent claims. Advantageous embodiments of the invention are described in the dependent claims.

In a first aspect, the invention relates to method of preparing a quantity of a food component for a plurality of consumption portions
a. Filling the hot-prepared food component at a temperature of at least 75° C. into a plurality of packaging units and then sealing the packaging units
b. Cooling the packaging units from a core temperature of at least 65° C. to a core temperature of less than 3° C. within 90 min or less,
   wherein the cooling of the packaging units in step c) is carried out in a water bath whose temperature is 3° C. or less.

In the method according to the invention, the food components for a food menu can be prepared according to traditional artisanal recipes. In particular, fresh, high-quality raw materials can be used to prepare tasty dishes. The thermal processing, i.e. the hot preparation of the food or raw materials, can be carried out by using machines and equipment known in the field of mass (communal) catering. The use of method facilitates or preserves ingredients such as flavor enhancers, colorants, preservatives, etc. is neither necessary nor preferred.

Rather, the method is characterized by the fact that the hot or warm preparation of the food components in step a) can be carried out according to traditional craftsmanship using fresh vegetables, fresh meat, herbs, etc. That means the warm or hot preparation, which preferably means a cooking method of the food components, can be done in a similar way as in traditional kitchens and benefit from the rich experience of traditional cooking.

With regard to communal catering and preferred provision of a large number of portions, the quantities and the cooking equipment used are preferably adapted. Particularly preferably, the hot preparation of the fresh food is carried out in an appropriately equipped central canteen (i.e. industrial, large-scale) kitchen.

The hot-prepared food components are preferably filled into sealable packaging units immediately after preparation at a still hot temperature of at least 75° C., preferably at least 79° C., especially preferably at least 81° C.

In the sense of the invention, the packaging unit preferably means a bag or tray which can hold a food component and is preferably made of a waterproof and airtight material. Plastic, for example, is suitable due to its ease of handling, light weight and the possibility of transparency. Preferably, the plastic is heat resistant up to a range of 100° C. or more, particularly preferably up to 130° C. or more. Herein, heat-resistant means, on the one hand, that at the temperatures mentioned herein not heat distortion such as stretching, shrinking, tearing or other deformation of the material of the packaging units occur. Furthermore, heat-resistant preferably means that there is no or negligible evaporation of the plastic in the temperature ranges mentioned, so that changes in the taste of the filled food components are excluded. Suitable plastic materials are sufficiently well known to those skilled in the art of food packaging.

The packaging units can take different shapes. For example, the packaging unit may be a substantially rectangular tray with an open side for filling the food components. A lidding film can be used for sealing. Also applicable is a bag, which provides an opening on at least one side for filling. The bag can, for example, be designed as a tubular bag closed on one of the shorter sides. Alternatively, the packaging unit can be a bag with a longitudinal seam and a closed seam on one of the opposite shorter transverse sides. Filling takes place on the respective open sides. Shrink bags, sealed edge bags or any other forms may also be used. For example, a packaging unit can be formed by a plastic film, which is given its appropriate shape by filling the food.

Following filling, the packaging unit is sealed. In the sense of the invention, sealing preferably means a closure of the packaging unit which is watertight and airtight. The sealing is intended to prevent both the food components from escaping from the packaging units and a possible entry of air contaminated with germs.

The sealing can be done in different ways. In the case of a bag, for example, the opening used for filling can be sealed with a weld seam. In the case of a tray, it is preferred to close the open side used for filling by means of a lidding or top film. It is particularly preferable to use an automatic thermoforming machine or similar packaging machines both for providing the packaging units and for sealing them. Suitable packaging machines are known from the prior art and the mode of operation of particularly preferred automatic thermoformers will be explained in detail below.

The method according to the invention is characterized in that cooling of the packaging units takes place in a water bath, the temperature of which is 3° C. or less, whereby the core temperature of the filled food components is guided from at least 65° C. to a core temperature of less than 3° C. within 90 min or less.

Core temperature preferably means the temperature in the center (or core) of the food component filled in the packaging unit. It is known that temperature changes caused from the outside are accompanied by a local temperature gradient, i.e. during cooling, the outside temperature of the packaging units will almost correspond to the temperature of the water bath, whereas inside the packaging units the temperature of the hot-filled food component will decrease in a retarded or delayed manner. The core temperature thus preferably indicates the residual heat still remaining in the food component and is thus a particularly relevant reference value with regard to the cooling process from the point of view of food hygiene. The concept of core temperature can be applied in an analogous manner to regeneration, whereby the delayed or retarded heating leads to a colder core temperature compared to the external temperature of the packaging unit.

When cooling hot-prepared food, it is of considerable importance that a temperature range of 3°-65° C. is passed through as quickly as possible, in particular a temperature range of 7°-50° C. The reason is the temperature-dependent reproduction potential of bacteria and germs relevant to food technology. Bacteria, viruses or fungi of particular hygienic concern include, for example, Salmonella, Escherichia coli, especially EHEC (enterohemorrhagic Escherichia coli), STEC, VTEC, Listeria, Enterobacter Sakazakii, Bacillus cereus, Campylobacter, Staphylococcus aureus, Vibriones, Clostridium perfringens, Clostridium botulinum, Yersinia enterocolitica.

Salmonella preferentially multiply in the temperature range of 10-47° C. Escheria coli, such as EHEC, can multiply preferentially in a temperature range of 7° C. to 50° C. With regard to multiplication, the optimum temperature for E. coli bacteria is around 37° C. In this range, the number of bacteria doubles every 20 min, resulting in exponential growth unless the temperature of the food component is brought out of the temperature range suitable for multiplication as quickly as possible.

During a hot preparation of the food component at temperatures above 75° C., the germs are largely killed and multiplication is excluded. Even in the target temperature range of less than 3° C., the multiplication potential of the germs is minimized. The temperature path of the cooling is therefore decisive for limiting the potential germ load of the hot-prepared food.

For the well-known Cook & Chill methods, DIN (German Industrial Norm) 10536 therefore specifies strict requirements for the cooling method (‘chill’). For the above reasons, the regulations require that food must be cooled from at least 65° C. to a maximum of 3° C. within 90 minutes, or in exceptional cases 120 minutes.

In the prior art, cold rooms or circulating cold air are mostly used for this purpose, which act on food components that are preferably stored in open catering trays. Increasing the air-cooled surface area ensures that cooling times of less than 90 min for a temperature drop from 65° C. to 3° C. can be maintained.

However, the air-based cooling method leads to adverse changes in the consistency, appearance, and nutritional as well as flavor content of the food components. In serious cases, incrustations may occur, for example, on mushy food components such as mashed potatoes. Meat or vegetable food components may also have dried out edge layers. It has been recognized by the inventors, however, that even if such obvious negative changes do not occur, air cooling leads to a loss of flavor or changes in consistency, which often only become apparent after regeneration.

Compared to the known methods, the cooling method according to the invention differs on the one hand in that the packaging unit protects the food components from degenerative methods during cooling. On the other hand, the use of the water bath with a temperature of less than 3° C. results in an extremely effective and fast cooling method, which also leads the core temperature of the packaging units through the temperature range of 7° C. to 50° C., which is problematic from a hygienic point of view, much faster than required by law.

The method steps described also allow the food components to be stored for a significantly longer period of time, for example more than 21 days, without posing a health risk when consumed.

The method according to the invention is also particularly advantageous from an economic point of view. On the one hand, it can be integrated in a simple and cost-efficient way into the method flow of preparing communal catering. In particular, no limitations or costly changes are necessary in the preparation compared to classic Cook & Serve methods. Traditional, high-quality cooking methods can be used in the fresh preparation of the food components. This results in nutritionally valuable and tastily distinctive meal or menu components. However, these menu components are sensitive in their structure, as they are produced without any use of artificial additives such as emulsifiers, stabilizers and regulators. For this reason, a new gentle cooling method and, in preferred embodiments, regeneration methods are provided for the produced menu components. Instead of serving the food components immediately, they are preserved, i.e. kept, by the method steps described without having to accept any loss of quality.

Furthermore, the packaging units provided are suitable for space-saving, secure storage and transport, so that the food components can be efficiently transported from a central preparation location, such as a commercial kitchen, to various end users.

In a preferred embodiment of the method, at least two or more, preferably three or more food components of a food menu are prepared, filled and cooled. In the sense of the invention, a food menu or just menu preferably refers to a dish with food components that are coordinated with each other. For example, it is common in many cultures to serve meat with a side dish and/or a vegetable as a dish or menu. A menu may, for example, be a leg of duck served with potato dumplings and red cabbage.

In the sense of the invention, the meal components are preferably components of a meal menu, which are prepared together. In the above example, the duck legs can be baked in an oven, for example, while the potato dumplings and the red cabbage are prepared in separate cooking pots. The food components can therefore also include different raw ingredients. For example, the red cabbage as a side dish can include both red cabbage and other ingredients for refinement, such as apples, sugar, vinegar, etc.

Preferably, filling is done in separate packaging units for each food component so that the taste and consistency are maintained independently.

Advantageously, the benefits of the method according to the invention can be achieved for a variety of different food components. A list which is not to be regarded as limiting includes, for example, boiled potatoes, potato dumplings, fried potatoes, rice, noodles, wholemeal noodles, croquettes, spaetzle, French fries, meat components such as chicken breast fillet, turkey escalope, beef or veal; beef steak, minced meat products (beef, pork, mixed in various forms such as Berliner Boulette, Königsberger Klopse, etc.), breaded pork escalopes, bratwurst, pork cutlets, lamb, Viennese sausages, duck, etc.), breaded pork cutlets, bratwurst, pork cutlets, lamb, lamb, pork sausage, etc.), breaded pork cutlets, bratwurst, pork chops, lamb, Vienna sausages, duck or goose (breast, leg), fish such as pollock, pike perch, pike perch, pike perch, pike perch, pike perch, pike perch, pike perch, pike perch, pike perch. Pollack, pike perch, cod, shrimp, crab, trout, salmon, breaded fish, vegetable side dishes, such as corn, peas, carrots, peppers, beet, red cabbage, Brussels sprouts, asparagus, as well as, separately or in combination with the above-mentioned food components, various sauces, such as gravies, tomato sauces, bell pepper sauces, cream sauces etc.

The above list is not exhaustive, but merely demonstrates the high degree of flexibility with which the method and the equipment can be used to reliably preserve and regenerate a wide variety of food components without any loss of quality.

The above-mentioned method steps in combination with regeneration by means of the device described herein surprisingly keep both vegetables crunchy and tasty and roasted meat crispy and juicy.

Furthermore, a surprisingly high content of secondary plant compounds (in vegetable and fruit components), of minerals, of numerous micronutrients, of optimal dietary fiber and a good composition of proteins and amino acids as well as healthy fatty acids can be observed. Both in terms of taste and health, the method according to the invention therefore lead to significant advantages over known prior art approaches.

In a preferred embodiment of the method, the hot preparation is performed by heating the food components to a cooking point, wherein the hot preparation is preferably performed in an open cooking container or cooking device, such as a cooking pot, cooking pan, roaster, steamer, oven, or the like.

For the purposes of the invention, cooking preferably means the treatment of food with heat to change its consistency, taste, digestibility and/or health effect. After sufficient cooking, the food is referred to as “cooked”. As is known, there are various cooking methods which can be used depending on the food component.

While approaches to preservation such as those described in U.S. Pat. No. 3,966,980 B2 are limited to vacuum cooking (sous vide), the method and the device are suitable for a wide range of food components and cooking methods. These include, for example, boiling, steaming, stewing, braising, roasting, baking, grilling, etc.

These and other traditional cooking methods can be used, with the skilled person knowing which cooking method is preferred for which food component.

In a preferred embodiment, the method is characterized in that the quantity of a prepared food component has a weight of more than 5 kg, preferably more than 10 kg, particularly preferably more than 20 kg, so that the quantity is preferably suitable for a number of more than 10, preferably more than 50, particularly preferably more than 100 consumption portions. The method is thus particularly suitable for the preparation of communal meals for a large number of consumers. For this purpose, it is preferred that the preparation of the meal components takes place at a central location, for example in a specially equipped commercial kitchen. The refrigerated packaging units produced can then be stored and transported to the various consumers in a decentralized manner.

This can be, for example, schools, kindergartens, work canteens, etc. Due to the particularly long shelf life of 21 days or more at a temperature of 8° C. or less, a particularly effective distribution and transport can also take place logistically. For example, a kindergarten can be supplied with the entire menu for that week only once a week. With known Cook & Serve methods, which require immediate, daily delivery, or Cook & Chill methods, which can often only guarantee a shelf life of four days even at temperatures of less than 8° C., such effective delivery is not possible.

From an economic point of view, logistics and delivery costs represent a considerable proportion of the menu price in mass or communal catering. In particular, if smaller facilities with a daily demand of less than 50 or even less than 30, 20 servings are to be supplied, the share of costs for logistics in the menu price can amount to 30% or more. Unfortunately, in order to be able to offer affordable prices despite the increased costs, the quality of the ingredients is cut in many places.

By providing the method according to the invention, a tasty and healthy diet can instead be provided on an economically sound basis, especially for smaller institutions such as kindergartens.

In a preferred embodiment, the method is characterized in that the packaging units have a capacity volume between 200 ml and 10 liters, preferably between 1 liter and 5 liters, particularly preferably between 2 liters and 3 liters.

Preferred capacities of the packaging units are between 200 ml and 10 L, particularly preferably 1 L and 5 L, most preferably between 2 L and 3 L. Intermediate ranges from the aforementioned ranges may also be preferred, such as 200 ml to 500 ml, 500 ml to 1 L, 500 ml to 3 L, 1 L to 2 L, 2 L to 3 L, 3 L to 4 L, 4 L to 5 L, 6 L to 7 L, 8 L to 9 L, or 9 L to 10. One skilled in the art will recognize that the aforementioned range limits may also be combined to obtain further preferred ranges, such as 500 ml to 2 L, or also 1 L to 3 L. The aforementioned package sizes represent an optimal balance in terms of the manufacturing method, and cooling method, efficient storage, delivery and regeneration.

Particularly good results for rapid cooling can be achieved with packaging units with the preferred capacities of 200 ml to 10 L, especially preferably 500 ml to 5 L, most preferably 1 L to 3 L. Surprisingly, however, DIN (German industrial standard) standard-compliant cooling is also possible with larger volumes, although in the latter case it is preferable to use flat packaging units with a raised surface.

Flat preferably means a ratio of the thickness of the packaging unit to the length or width of the packaging unit of 1:2, 1:3, 1:4, 1:5, 1:10 or more.

For cooling, food components still at a temperature of at least 65° C. and packed in the packaging unit are preferably cooled in a water bath at a temperature of less than 3° C., preferably at a temperature of approx. 1° C.

For this purpose, for example, a water tank open at the top can be provided.

In a preferred embodiment of the method, the water bath for cooling the packaging units is equipped with one or more immersion baskets with compartments for the packaging units. It is particularly preferred that a continuous cooler is connected to the water bath to ensure a temperature of 3° C. or less during cooling.

In this embodiment, the water bath or water tank is equipped with immersion baskets, preferably stainless steel baskets, into which the packaging units can be layered. The water tank or the water bath can thus preferably be filled layer by layer up to the upper edge of the water tank. Advantageously, an intermediate space is created between the baskets, allowing water to circulate. After the packaging units have been filled into the water tank, it is preferable to fill it with water also up to the upper edge. In this case, a maximum volume of the water bath (i.e. the volume of the heat transfer medium) is achieved, with the internal volume of the water tank corresponding to the volume of the water bath.

It has proven to be particularly advantageous to use a heat exchanger or circulating cooler. The circulating cooler preferably comprises an intake and an inflow channel with which it is connected to the water tank. Preferably, by means of the intake channel on one side of the water tank, the water heated by the packaging units is drawn out, while the water cooled by the circulating cooler to less than 3° C. flows back in again, preferably 1° C. Examples of suitable heat exchangers or circulating coolers are devices from HYFRA Industriekühlanlagen GmbH, HYFRA Sigma series, Germany.

Excellent cooling results and core temperature profiles can be achieved at a volume exchange rate by means of the circulating cooler, which exchanges the volume of the water tank (e.g. 2500 L) within less than 90 min, preferably less than 60 min, particularly preferably 30 min or less.

In a preferred embodiment, the method is characterized in that the filling according to step b) of the method is carried out with the aid of an automatic thermoforming machine, which carries out the following steps automatically:
i. Embossing of packaging units in tray form, preferably from a transponder foil
ii. Filling of the food components at a temperature of at least 75° C. into the packaging units.
iii. Steam rinsing of the packaging units with steam of a temperature of 100° C. or more, preferably 120° C., 130° C. or more
iv. Sealing of the packaging units, preferably by means of a top film

In the sense of the invention, an automatic thermoforming machine preferably means an automated system with at least one thermoforming station for embossing packaging units and a sealing station for sealing the packaging units, as well as possibly further work stations for carrying out the necessary steps for filling and sealing the packaging units. Preferably, the various work stations are interconnected by a conveyor belt which enables automated transport of the packaging units from embossing through filling to sealing.

Embossing preferably means the shaping of packaging units from a material suitable for this purpose, preferably plastic films, into a mold which is suitable for receiving the food components to be filled. Tray shape means a shape of the packaging unit which has a recess for receiving the food component. For example, rectangular trays can preferably be used for filling. However, packaging units can also be prefabricated in the form of a bottom film with a trough shape, into which the food components are filled. If a flexible film is used, the final shape of the packaging tray can be flexibly adapted to the filled quantity of food components. In the case of the use of rigid films (semi-rigid), the packaging unit will have the embossed shape, preferably tray shape, even during the filling method. Particularly preferred is the use of a transponder film which is approved for the food industry.

In a particularly preferred embodiment, a size of shell desired for the packaging unit is formed from a transponder film approved for the food industry using compressed air and a flexible tool. After embossing, the formed trays are preferably connected to each other in succession and run through the filling area of the machine at an adjustable rate, preferably by means of a conveyor belt.

The filling method can be performed by an automated filling station as part of the thermoforming machine, or it can be performed manually. In the latter case, the thermoformer will preferably include an accessible area of the assembly line to allow manual filling.

According to the invention, the food components are filled while they are still hot and have a temperature of at least 75° C., preferably 81-95° C. The food components are thus packaged in the so-called hot fill method in the packaging machine. The food components are thus packaged in the packaging machine in a hot fill method.

Before the packaging units are sealed, steam purging is preferably carried out by means of steam of a temperature of 100° C. or more, preferably 120° C., 130° C. or more. This replaces the head space of the packaging unit, i.e. the space of the packaging unit above the filled food component, with hot water vapor, preferably of the above temperature ranges. For this purpose, a corresponding steam generation unit is preferably integrated directly in the sealing station so that sealing takes place without distortion after steam flushing.

Steam rinsing can ensure that open surfaces of the packaging units or the food components are freed from adhering germs and that a germ-free packaging unit is present immediately before sealing.

The packaging units are preferably sealed in a manner known in the prior art by means of a lidding or top film which seals the filling opening of the tray. Composite films can be used here, for example, which have a backing layer and sealing layer. Lidding films can also be made of composites such as PA/PE or laminated composites. A skilled person in the field of packaging technology is familiar with the techniques and materials described above. He will therefore select a suitable film and method to achieve a seal that meets the food technology requirements. Preferably, the result is a packaging unit with a filled food component without air pockets.

Preferably, the sealing achieves an airtight and liquid-tight closure of the package, which completely excludes the entry of germs. Sealing in direct succession to steam rinsing, in conjunction with cooling according to the invention, achieves particularly long shelf lives for the food components. The food component is hermetically sealed and packaged with low germ content. The product can preferably be kept for 21 days or more by the method without downstream pasteurization. Color, consistency, taste and nutritional content of the food components are fully preserved.

Desired or legally required information can be applied to the packaging unit by marking the top or lid film. For this purpose, the thermoformer can include a film printer, for example.

Embossing, filling, steam rinsing and sealing of the food components by means of an automatic thermoforming machine is known in the prior art and a skilled person is able to provide suitable equipment. Suitable thermoforming machines or systems are also commercially available. Such devices are offered, for example, by VARIOVAC PS SystemPack GmbH under the Primus, Primus MP, Optimus product series (each designed for Variosteam applications).

In a preferred embodiment, the method additionally comprises the following steps
I. Storage of the packaging units at a core temperature of 8° C. or less
II. Heating the packaging units, preferably at the desired place of consumption, from a core temperature of less than 8° C., to a core temperature of more than 65° C., preferably to a core temperature between 70° C. and 74° C. in a water bath at a temperature between 80° C. and 90° C., preferably 83° C.-87° C., particularly preferably about 85° C.

Refrigerated storage of the packaging units preferably follows immediately after cooling to a core temperature of less than 3° C. An interruption in cooling should be avoided, so that the core temperature of the packaging units may rise from less than 3° C. to a maximum of 8° C. between cooling in the water bath and subsequent refrigerated storage. Refrigerated storage may initially preferably take place centrally in a cold store at or near the place where the food components are prepared. Such a cold storage facility can, for example, be provided in the immediate vicinity of a commercial kitchen set up for the preparation of the food components.

Preferably, the food components are then delivered to the various decentralized recipients, such as schools, kindergartens, and possibly also individuals or supermarkets. During delivery and at the customer's premises, refrigeration is maintained at 8° C. or higher. Even during delivery, the cold chain should not be interrupted in order to ensure the particularly long shelf life of the packaging units.

From a practical point of view, the preferred volumes of 200 ml and 10 liters, preferably between 1 liter and 5 liters, 2 liters and 3 liters, have proved particularly advantageous. On the one hand, these allow space-saving delivery. On the other hand, the packaging units can be easily layered into existing refrigeration equipment (refrigerators, etc.) at the end users. Sealed packaging units, especially for volumes of 1-5 liters, also ensure that even brief exposure of the packaging units to room temperature does not result in an increase in core temperature.

The customers may preferably be communal facilities such as schools, kindergartens, hospitals, work canteens, etc. However, individual customers may also be supplied. In previous meals on wheels concepts, Cook & Hold is used for individual customers, such as senior citizens. That means menus are delivered while still hot immediately after preparation, with temperature-insulating containers retaining the heat. The daily delivery of individual portions is a considerable logistical effort, which leads to significant additional costs per meal. Also, keeping food hot for a period of often several hours affects the taste and consistency of the food. For example, the vegetables continue to cook during the time of keeping the food warm and loose their firmness to the bite by the time they reach the end consumer.

In contrast, the method according to the invention allows refrigerated delivery of multiple portions for the entire week. By transporting the food to individual customers on a weekly, rather than daily basis, unnecessary trips can be avoided. The saved costs can instead be invested in high-quality food for the preparation of the meals.

The regeneration of the food components takes place preferably at the desired place of consumption, i.e. e.g. in the respective community facility (kindergarten, school, etc.) or at the individual consumer by means of a water bath.

For the purposes of the invention, regeneration preferably means restoring the food component from a refrigerated state during storage to a temperature that is comfortable for consumption.

Reheating is performed as described above using the device with a temperature between 80° C. and 90° C. preferably from a core temperature of less than 8° C. to a core temperature of more than 65° C., preferably to a core temperature between 70° C. and 74° C.

The reheating time, i.e. the duration of the regeneration, warming-up or heating process of the packaging units, can preferably be adapted to the size of the packaging units. For example, a shorter immersion in the heat bath will be necessary for smaller capacity volumes for individual consumers of 200 ml and 1 L than for larger packaging units for communal facilities with capacity volumes between 1 L and 10 L.

For particularly preferred packaging unit volumes of 1 L to 5 L, preferably of 2 L to 3 L, a reheating time of 35 min to 55 min, particularly preferably of 40 min to 50 min, most preferably of about 45 min, has proved advantageous.

In a preferred embodiment of the method, thus, the heating of the packaging units takes place in a period between 35 min and 55 min.

By reheating the food components in a water bath from 80° C. to 90° C., preferably 83° C.-87° C., particularly preferably about 85° C., surprisingly excellent regeneration results can be achieved. A wide variety of food components, from meat products such as duck leg, to vegetable side dishes such as red cabbage, to mashed potatoes, can be regenerated by means of the water bath in such a way that a quality comparable in every respect to freshly prepared food is achieved. Due to the related temperature range of 80° C.-90° C., undesired after-cooking is avoided. Due to the minimum temperature of 80° C., the gentle preparation is nevertheless fast enough to preserve the structure of various food components. The temperature range of 80° C.-90° C., has thus proven to be surprisingly advantageous.

Energy regeneration by means of the device at a water bath precisely controlled and tempered by the components of the device ensures that a preserved quality of the cooled (refrigerated) food components is not lost during reheating before consumption.

In the state of the art, it is common practice, especially in communal kitchens, to regenerate preserved packaged menu components in large bain-marie containers by means of hot air.

The associated loss of moisture leads to dehydration and loss of quality in terms of taste, visual appearance and the content of nutrients and trace elements. In contrast, the device maintains the taste, consistency and nutritional content of the high quality preparation of the food.

In contrast, the method described maintains both the taste, consistency and nutritional content of the high quality preparation.

Surprisingly, better results may moreover be achieved by means of the device than is the case with conventional reheating methods using appropriate cooking or frying containers. With individual reheating of food components in separate cooking pots, frying pans or the like, it is extremely difficult to match the optimum reheating temperature and reheating time at which regeneration is completed without the food components continuing to cook and valuable nutrients and flavors degenerating. Instead, the device provides controlled reheating under repeatable conditions that compensate for deviations and reliably produce satisfactory results.

The combination of the cooling and regeneration steps thus leads to synergistic effects that go far beyond the aggregation of the individual features.

In principle, various devices can be used to carry out the regeneration, which allow precise adjustment of the temperature of a water bath between 80° C. and 90° C. However, the advantages of the regeneration method according to the invention can be achieved in a particularly simple and reliable manner with a device developed specifically for this purpose.

In a preferred embodiment, the method is characterized in that for heating the packaging units a device is used, comprising
a housing
a water tank to hold water and a lid to close the water tank
an immersion basket with compartments for packaging units of refrigerated preserved food components for insertion into the water tank
at least one electric heating element for heating the water
a pump to circulate the water
a control unit
   wherein the control unit is configured to regulate the power supply to the electric heating element during a heating method such that the water temperature is maintained at a fixed heating temperature in a range of 80°-90° C. for a predetermined heating time.

In the sense of the invention, a water tank preferably designates a container which is liquid-tight and suitable for holding water. Various materials can be used for the water tank, for example plastic, metal elements, in particular iron, aluminum or copper, and metal alloys, in particular bronze, brass, or steel, especially preferably stainless steel. These materials have high durability and an attractive appearance. Particularly preferred materials, such as stainless steel, are also rustproof, so that unnecessary wear is avoided. In some embodiments, it may also be preferred to cover the water tank on the inner surface with a coating that increases the mechanical resistance or chemical resistance, for example by means of an enamel or a ceramic coating.

In terms of shape, the water tank can be of various designs, preferred embodiments being cylindrical or rectangular, for example. Preferably, the water tank comprises a bottom, one or more shell surfaces, and an upper opening for inserting the packaging units. The upper opening is closable by means of the lid. The openings and the lid are thus preferably congruent and of the same size.

The housing essentially provides an enclosure for the water tank as well as the other technical components of the device, including the control unit or pump. The housing stabilizes the device and protects it from external influences. In a preferred embodiment, the housing is made of stainless steel sheet, which is equipped with a pressed retaining sheet or overlapping sheet to the water tank in the upper part of the housing. The retaining sheet or overlap sheet increases the cohesion of the device and, especially in conjunction with two additional seals (to the outer casing as well as to the water tank), protects the device technology and electronic components from water damage.

The housing is preferably water resistant, so that even in the event of high humidity or spillage of liquid onto the device, internal electronic components remain intact and no short circuit occurs. In preferred embodiments, wheels, preferably fixable wheels, are attached to the housing so that the device can be pushed in a freestanding manner and locked in place for application purposes.

An immersion basket is preferably a device for layering or holding the packaging units, which has compartments specially dimensioned for this purpose. Preferably, each of the compartments is bounded by at least two grid surfaces. Preferably, the packaging units rest on a lower grid surface and are prevented from floating up by an upper grid surface. Thus, both food components with higher density than water (e.g. meat) and those with lower density (e.g. pasta) are reliably held in the compartments. The grid surfaces can be formed by metal grids, for example, with the grid openings ensuring uniform water exchange and surface rinsing of the packaging units. The use of an immersion basket not only allows easy handling for filling the water tank with the packaging units, but also ensures uniform distribution of the packaging units in the water tank due to the predetermined grid compartments, so that all packaging units are heated evenly and reliably.

The electrical heating element is a component with which thermal energy can be supplied to a quantity of water in the water tank. Preferably, the electrical heating element comprises a power resistor, for example a heating coil, at which a well-defined temperature is generated in dependence on the current flow. The power resistor or heating coil is electrically insulated from the water to be heated and may be present, for example, in a tubular sheath. Various electric heating elements are known in the prior art. For example, these are used in household appliances such as instantaneous water heaters, washing machines, toasters, hair dryers, irons, coffee machines, etc.

In the sense of the invention, the control unit is preferably a simple electrical circuit, a processor, a processor chip, microprocessor, microcontroller or integrated circuit configured to control electrical components of the device, such as the pump or the heating element. Preferably the control unit is configured to regulate the temperature of the water inside the water tank by means of the at least one heating element according to predetermined values and to maintain it at a heating temperature selected from a range of 80°-90° C., preferably 85° C., during the warming-up process.

Preferably, the control unit can control which temperature is present in the water tank by presetting a predefined current supply to the heating element. For example, a calibration can be used to determine the correlation between current flow and/or voltage at the heating element with the temperature in a filled water tank.

However, it is particularly preferred to regulate the water temperature by means of a feedback loop. Thus, it may be preferred to use a temperature sensor which determines the temperature of the water in the water tank, wherein the control unit regulates the current supply to the electric heating element on the basis of said temperature sensor.

For this purpose, the control unit may comprise, for example, a processor, microprocessor or integrated circuit which can evaluate measurement data and define current parameters. However, it may also be preferable to use a thermostat as a temperature sensor, which is set to a predefined temperature, for example 85° C., and only allows current to be supplied at temperatures below 85° C., whereas at temperatures above 85° C. the current supply is automatically interrupted. In this way, the temperature can be controlled extremely efficiently and reliably.

To maintain a homogeneous temperature distribution within the water tank, the use of a pump is provided in the device.

In the sense of the invention, a pump preferably means a device for sucking in or sucking out liquids, preferably water. Particularly preferably, the pump is a circulating pump which, for example, draws water from the lower end of the water tank to direct it to the upper end. For example, it may be an HST circulation pump. The pump, preferably a circulation pump, can thus ensure that the water is constantly fed past the heating elements during heating in order to realize rapid heating or to ensure that a desired heating temperature is maintained. The pump is preferably driven electrically, via an appropriate electric motor.

In a preferred embodiment, the water tank may further comprise a shaft impeller or other circulation device (propeller, etc.) that keeps the water heat transfer medium in motion so that the applied energy achieves its maximum efficiency in the shortest time.

By using a pump, if necessary supported by a shaft impeller, the packaging units in the immersion basket equipped with grid compartments are at all times immersed by optimally tempered water.

The interaction of the components of a pump, as well as a shaft impeller if necessary, with the immersion basket provide excellent results in terms of heat distribution within the water tank and ensure uniform circulation around the packaging units as well as high-quality regeneration.

When cooled or refrigerated packaging units are added, for example at a temperature of less than 3° C., the temperature in the water bath drops briefly. However, the regulation of the device quickly and reliably tracks the temperature in the range of 80°-90° C., especially preferably 85° C.

The device is therefore particularly suitable for carrying out a regeneration method and ensuring gentle reheating of the food components, which preserves the structure, taste and nutritional content of the food.

The control unit is configured to maintain the water temperature at a reheating temperature of 80°-90° C. min for a predetermined warm-up time. By reheating the food components in a water bath from 80° C. to 90° C., preferably 83° C.-87° C., particularly preferably about 85° C., surprisingly excellent regeneration results can be achieved.

Energy regeneration by means of the device at a water bath precisely controlled and tempered by the components of the device also ensures that a preserved quality of the cooled (refrigerated) food components is not lost during reheating before consumption.

In a preferred embodiment, the reheating temperature is fixed in the device. In relation to the reheating (heating, warming-up) temperature, fixed preferably means that the device does not provide for the possibility of a change or selection of the reheating temperature by a user.

A reheating temperature selected from a range between 80° C. and 90° C. is thus preferably specified as a process parameter for the device, without any external options for changes by a user being provided. In devices known in the prior art, it is provided to set different temperatures for the water baths. For example, in known sous-vide devices, different adjustable water bath temperatures are thus provided in order to adapt the cooking temperatures to different components.

The inventors have recognized that for regeneration of refrigerated preserved food components for communal catering, such adjustment options can have a detrimental effect on regeneration results.

Thus, by carrying out numerous tests, a surprisingly optimal regeneration temperature was determined in the range of 80° C. to 90° C., preferably about 82° C.-87° C., and particularly preferably about 85° C. Experience has shown that possible deviations due to individual user settings do not lead to an improvement but rather to a deterioration in quality in the context of a process optimized for mass catering. Thus, in the provision of high-quality communal catering, it is preferable to coordinate the process steps and particularly good regeneration is ensured by repeatable, constant process conditions. The preferred embodiment ensures this by simple means of defining a reheating (re-warming) temperature.

Such an embodiment also protects against operating errors. For example, it is not uncommon in communal facilities with fixed meal times (e.g. hospitals, kindergartens, etc.) that time pressure causes employees to upregulate the intended reheating temperatures in known reheating devices (especially hot fans) in order to speed up the reheating process. While this approach results in food being ready more quickly, quality suffers disproportionately. With a fixed reheating time, such operating errors can be avoided and a consistently high food quality can be provided.

The fixed setting of the reheating temperature at the device can be done in different ways.

In a preferred embodiment, the device for fixed setting of a reheating temperature comprises a thermostat, with a fixed temperature from a range between 80° C. and 90° C., particularly preferably 82° C.-87° C., more preferably about 85° C. Preferably, the thermostat allows power to be supplied only at temperatures below the fixed reheating temperature and interrupts the power to the heating elements at temperatures above the reheating temperature so that the water temperature is kept constant in the desired range.

A thermostat is understood to be the component known from the state of the art, which preferably means a temperature controller that allows the actual value of a temperature to be detected with the aid of a temperature sensor, compared with a specified setpoint value and a desired (specified) setpoint value to be set via an actuator. A thermostat may denote a temperature controller, as well as only the temperature sensor or temperature probe without an actuator. Various variants of thermostats are known in the prior art, for example, a bimetallic temperature switch may be suitable.

In a preferred embodiment, the device comprises a temperature sensor for monitoring the water temperature, and the monitoring is preferably used for the fixed setting of the heating temperature.

In the sense of the invention, a temperature sensor is preferably an electrical or electronic component which generates an electrical or mechanical signal depending on the temperature at the sensor. A variety of temperature sensors are known in the prior art, such as semiconductor temperature sensors, resistance temperature sensors, pyroelectric materials, thermocouples or oscillating crystals. Preferably, a thermostat is used as the temperature sensor.

The temperature sensor can be connected to a control unit so that the latter can record and evaluate the measured values of the temperature sensors in order to effect regulation of the heating element. The regulation of the electrical heating element can preferably take place with the aid of the application of an electrical current or voltage. However, the temperature sensor can also be in the form of a thermostat, for example, which allows or interrupts the current supply depending on the temperature as described above.

It is particularly preferred that the temperature sensor measures the temperature of the water introduced into the water tank directly, i.e. that the temperature sensor is in contact with the water. For this purpose, the temperature sensor may, for example, be present on an inner surface of the water tank, may extend into the capacity volume of the water tank, or may be present in water lines that are in fluid communication with the water tank. In the case of a thermostat, a sensor is preferably brought into contact with the water, with the actuator being present within the control unit, preferably in the form of an electrical circuit.

Taking into account the temperature of the water allows for a particularly precise regulation of the electric heating element to ensure optimum temperature distribution within the water tank and thus heat transfer to the packaging units.

In preferred embodiments, the device may also have multiple temperature sensors, for example two, three or more, which are located at different positions inside or outside the water tank. In this case, the control unit will preferably regulate the electrical power supply to the at least one heating element on the basis of a possibly weighted averaging of the results of the multiple temperature sensors.

Preferably, a fixed setting of the reheating time is realized by means of the at least one temperature sensor. In the case of a thermostat, this is usually predefined by hardware. However, a fixed setting can also be carried out by software or firmware. In the sense of the invention, firmware is preferably understood to mean software, i.e. instructions for a computer-implemented method, which is embedded in the control unit, for example in the form of a microprocessor. That means the firmware preferably comprises said software which is functionally connected to the hardware of the device, i.e. in particular to the heating elements, possibly temperature sensors or an electric pump. For the fixed setting of the reheating or warm-up time, for example, a corresponding reheating time can be specified in the firmware. Changes to a reheating time in the firmware would only be possible by technical personnel with the appropriate equipment and cannot be made by a user when using the device, so that the aforementioned advantages of consistent quality assurance are provided.

In another preferred embodiment, the control unit is configured to regulate the power supply to the electric heating element during the reheating process such that the water temperature is maintained at a reheating temperature of 80°-90° C. for a predetermined reheating time, which is 35 min to 55 min.

In a particularly preferred embodiment, the control unit is configured to regulate the power supply to the electric heating element during the reheating process such that the water temperature is maintained at a reheating temperature of 80°-90° C. , preferably between 83°-87° C., more preferably about 85° C. for a predetermined heating time, which is from 35 min to 55 min, preferably from 42 min to 48 min, more preferably about 45 min.

In the sense of the invention, indications such as approximately, nearly or synonymous terms preferably denote a tolerance margin of less than ±10%, preferably less than ±5%, particularly preferably less than ±1%. Pre-determined reheating or warm-up time preferably means that a reheating or warm-up time is predetermined for the device for the reheating method (i.e. warm-up or regeneration method), i.e. that the reheating process does not occur for an indefinite time. The predetermined reheating time can be fixed, available as a device parameter or selectable for the user from different reheating times.

The reheating time, i.e. the duration of the regeneration, warming-up or heating process of the packaging units, can preferably be adapted to the size of the packaging units, as explained above. For example, a shorter immersion in the heat bath at a temperature of 80° C.-90° C. will be necessary for smaller capacity volumes for individual consumers of 200 ml and 1 L than for larger packaging units for communal facilities with capacity volumes between 1 L and 10 L.

For particularly preferred packaging unit volumes of 1 L to 5 L, preferably of 2 L to 3 L, a reheating time of 35 min to 55 min, particularly preferably of 40 min to 50 min, most preferably of about 45 min, has proved particularly advantageous.

If the device is to be used for different packaging sizes, a user-dependent setting of the reheating time may be preferred. It is also conceivable that by means of a coding of the packaging bags, for example a QR code, the device can automatically read out the suitable reheating time. For this purpose, in preferred embodiments, the device has corresponding sensors and evaluation units.

In a preferred embodiment, the reheating time is fixed by means of a time relay. A time relay is preferably a combination of a relay and a timer, with the aid of which switch-on or switch-off delays can be achieved in control and automation technology. Various embodiments are known to the skilled person for this purpose. For example, an electronic time relay can be used, whereby, for example, a digital circuit with oscillator, frequency divider, counter and/or comparator, among other things, can be used as a multifunction relay with a microcontroller.

With regard to alignment and optimization of the method steps in communal or mass catering, it is particularly preferred to set the heating time inherently in the device, for example by means of a time relay which is present in an electronic circuit as a control unit, so that the device is designed for a preferred size of packaging units or a preferred range of sizes of packaging units.

However, different devices can also be provided for different applications and sizes of packaging units, for example. For example, for applications in communal facilities such as kindergartens or schools, it may be preferable to provide a device with a fixed reheating time of 35 min to 55 min, while for uses of individual consumers, for example for regeneration of the food components in a home setting (e.g. for so-called meals-on-wheels deliveries), fixed reheating times of only 15 min to 30 min for capacity volumes of 200 ml to 1 L may be preferred.

In a preferred embodiment, the compartments of the immersion basket are grid compartments, wherein the immersion basket comprises between 2 and 10, preferably between 4 and 8 compartments.

Particularly preferably, the grid compartments are flat, the ratio of the height of the grid compartments to their length or width being 1:2, 1:3, 1:4, 1:5, 1:10 or more. In this manner, flat packaging units, as described above, can be layered in a particularly preferred manner. Due to their flat dimensions, such packaging units have a particularly high surface area, so that regeneration can be carried out particularly quickly, but at the same time with minimum impact on quality.

With the flat dimensioning of the compartments, the packaging units can be arranged horizontally flat on top of each other.

On the one hand, the arrangement facilitates the stacking of the packaging units and the insertion of the immersion basket into the water tank. On the other hand, the horizontal storage of the packaging units in the immersion basket itself ensures that the food component is distributed over the maximum surface area of the packaging units. Due to the horizontal storage, the preferred packaging units provide the maximum surface area for the food components. In this way, the heat transfer medium water can transfer its heat with maximum efficiency to the food components. Especially with liquid and semi-liquid consistencies of the food components, the arrangement has a surprisingly positive effect on the regeneration time and quality.

In a preferred embodiment, the water tank has a width of 30 to 40 cm, a depth of 20 to 30 cm and a height of 45 to 60 cm. These dimensions have proven to be particularly advantageous for heating the preferred packaging units with capacity volumes of 200 ml to 10 liters, preferably between 1 liter and 5 liters, especially preferably between 2 liters and 3 liters.

Especially in combination with an immersion basket of the preferred configuration, excellent regeneration results can be reliably achieved.

In a preferred embodiment, the water tank exhibits a capacity volume of 10 to 100 L, preferably of 20 to 80L, 30 to 70 L, 40 to 50 L. The aforementioned volumes proved particularly advantageous for the reheating of the preferred packaging units with capacity volumes of 200 ml to 10 liters, preferably between 1 liter and 5 liters, particularly preferably between 2 liters and 3 liters. In particular, when four or more, preferably six or more packaging units are to be regenerated simultaneously. For example, when using six packaging units of 3 L each and filling the water tank with 17 L of water. Taking into account the displacement volume of the immersion basket in a particularly preferred water tank with a capacity of approx. 45 L, the water tank is almost completely filled.

The preferred dimensions and capacity volumes of the water tank are thus matched to particularly preferred sizes and numbers of packaging units, whereby a ratio of between 1:3 and 3:1, preferably between 1:2 and 2:1, of the volume of the packaging unit to the volume of the heat transfer medium water has proven to be surprisingly energy-efficient.

In a preferred embodiment, the device comprises two heating elements, which are enclosed in cladding tubes, preferably made of stainless steel, and are horizontally aligned in the lower fifth of the water tank above the bottom of the water tank. The term lower fifth refers to the height of the water tank and horizontal preferably means parallel to the bottom of the water tank and perpendicular to the shell or side surfaces. Preferably, one or more storage rails are installed above the two heating elements, likewise preferably horizontally aligned, for receiving the immersion basket.

The positioning of two heating elements below the immersion basket leads to particularly effective heating of the water in the water tank. Convection currents occur during positioning, which ensure optimum rinsing of the packaging units during the heating method without additional energy supply. In terms of both energy efficiency and regeneration results, this embodiment is therefore a particularly advantageous configuration.

In another preferred embodiment, the water tank comprises an outlet opening in the bottom and an inlet opening in an upper third, which are connected to each other via a water line and a pump, wherein the pump is configured to draw water from the outlet opening in the bottom of the water tank and feed it into the inlet opening in the upper third of the water tank.

The indication of the top third preferably refers to the height of the water tank, where top and bottom indicate the direction of gravity in the case of an upright device ready for use. Water lines are preferably pipes. Such a configuration ensures in a compact manner that the water as a transfer medium is constantly led past the heating elements during heating.

This makes it possible to achieve particularly rapid preheating. During the heating phase, the pump also ensures that a temperature in the preferred range of 80° C. to 90° C. can be kept particularly stable.

In another preferred embodiment, the water tank comprises an outlet opening in the bottom and the housing comprises a discharge or drain opening, which are connected to each other or connectable in a valve position via a water line and a pump, wherein the pump is configured to draw the water from the outlet opening in the bottom of the water tank and to discharge it via the discharge or drain opening. Advantageously, the pump can be used not only to circulate and thus effectively and in a controlled manner heat the water bath, but also to quickly and safely discharge the water from the water tank after operation. Dangerous and tedious emptying of the container by hand is not necessary. Instead, the draining can be automated by means of a simple operation.

It is particularly preferred that the water connection can be changed between two settings by means of a valve. While in a first setting for circulation water is conveyed from a discharge opening in the bottom of the water tank to an inlet opening in the upper end of the water tank, in a second setting for a pumping-down or draining there is a connection between a lower outlet opening in the bottom of the water tank with a discharge opening in the housing. This embodiment is space-saving and surprisingly robust.

In a preferred embodiment, the device comprises locking means for the lid, wherein the control unit is configured to lock the lid during the heating method preferably for the predetermined reheating time. On the one hand, the locking mechanism serves a safe operation of the device, which excludes that unauthorized persons scald themselves by the hot water during the reheating process. On the other hand, the locking mechanism ensures that the regeneration of the packaging units takes place over the designated time and is not terminated prematurely.

Various components known from the state of the art can be used as locking means, for example a latching or locking mechanism, which can be moved between a locking and an unlocking position by means of the control unit.

The embodiment ensures, especially in the context of a reheating temperature set on the control unit, a particularly robust operation of the device, which reliably provides the best regeneration results regardless of the user's level of experience.

Experience has shown that, particularly in communal facilities, time pressure often leads employees to upregulate the intended temperatures in hot air blowers known in the prior art in order to speed up the heating method, but quality suffers as a result.

By providing a device which does not allow manual adjustment of the reheating temperature, operating errors are inherently excluded. Such a device thus comprehensively ensures a high-quality standard, largely independent of the user.

In order to increase user-friendliness, it is also preferable to provide a streamlined and intuitive operating concept.

In a particularly preferred embodiment, the device is equipped with only one main switch for start-up (ON/OFF), optionally a switch position for a pump-down or drain, as well as a button for starting the reheating program and one or two indicator lights.

Preferably, switching on by means of the main switch causes the water bath to be preheated to an operating temperature of, for example, 72° C. or more. A control lamp can indicate the method temperature reached. After the packaging units have been placed in the immersion basket, the latter placed in the water tank and the lid closed, the reheating program can be started by means of the pushbutton. As described above, the control unit maintains a water temperature of 80°-90° C. during the actual reheating or regeneration program in order to bring the packaging units to a desired core temperature of at least 72° C. After completion of the reheating process, preferably after 35 min to 55 min, a second control light can indicate the end of the process. Preferably, a locking mechanism regulated by the control unit keeps the lid closed during the entire regeneration (reheating) program. When the process is completed and the corresponding control lamp is displayed, the unlocking mechanism is released so that the packaging units can be removed.

The disclosed preferred embodiments of the invention exemplify the teaching according to the invention. The average person skilled in the art will recognize where and to what extent he can vary certain technical features or replace them with equivalent features. The teaching according to the invention represents a combined invention in which initially certain areas and technical features are selected. These selected features are combined in such a way that a surprising result can be achieved. This surprising result consists in particular of provided food components which have a surprisingly high vitamin content or a surprisingly high content of healthy unsaturated fatty acids and further exhibit a surprisingly low microbiological load.

Furthermore, it was completely surprising that the so-called canteen or communal food or communal or mass catering can be provided as hot food in a way that is usually only known from individual preparation in the prior art. For example, it was completely surprising to find that the known cooling by a cold air method has similar effects on the food as freeze-drying, adversely affecting numerous micronutrients and vitamins in the food. It is to the credit of the inventors to have provided a method and apparatus for generating communal food which, as warm food, is characterized by a surprisingly high content of phytochemicals (in vegetable and fruit components), of minerals, of numerous micronutrients, of optimal dietary fiber, of a good composition of proteins and amino acids, and of healthy fatty acids.

In the following, the invention is described with reference to further figures and examples, without being limited to the latter.

### SHORT DESCRIPTION OF THE IMAGES

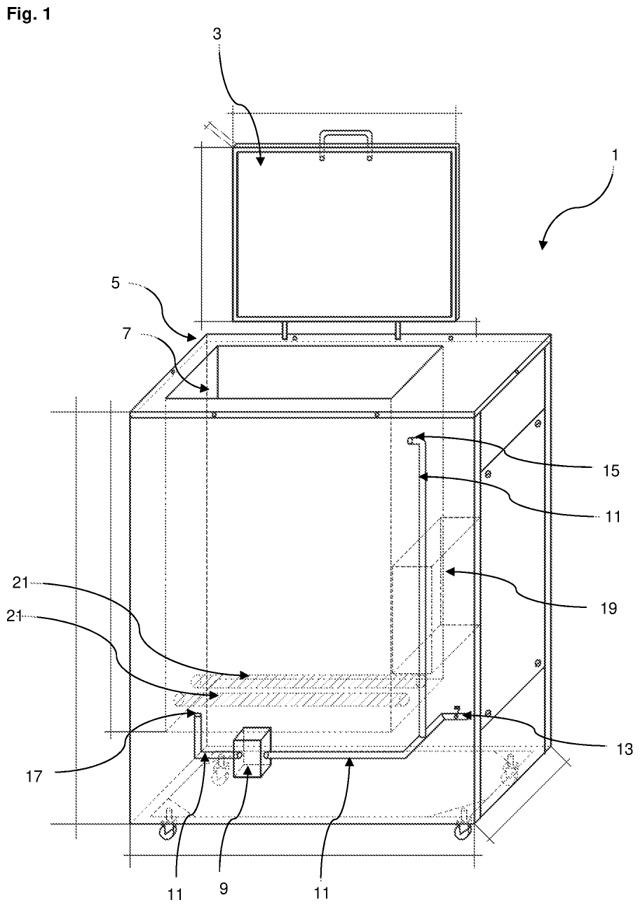

FIG. 1 Schematic representation of a preferred embodiment of a device for heating the packaging units

### DETAILED DESCRIPTION OF THE IMAGES

FIG. 1 shows a schematic view of a preferred embodiment of a device 1 for heating packaging units, comprising a housing 5, a water tank 7 for holding water and a lid 3 for closing the water tank, an immersion basket (not shown) with compartments for packaging units of refrigerated preserved food components for insertion into the water tank 7, at least one electric heating element 21 for heating the water, a pump 9 for circulating the water, a control unit 19, wherein the control unit 19 is configured to regulate the power supply to the electric heating element 21 during a heating method such that the water temperature is maintained at a heating temperature of 80°-90° C. for a predetermined heating time.

The device 1 comprises a housing 5 in the form of a casing (preferred width=55.5 cm, depth 36.0 cm, height=72.5 cm) made of stainless steel sheet (preferred thickness 2 mm). In the upper part of the housing 5, there may be a pressed retaining plate or overlap plate to the water tank 7, which promotes the cohesion of the device and, in conjunction with two seals (one each to the device housing and to the water tank), protects the electrical components from water damage.

At the core of the device 1 is a rectangular water tank 7 (preferred dimensions: width=34.0 cm, depth 25.0 cm, height=52.0 cm) made of stainless steel sheet (preferred thickness: 2 mm thick). The water tank 7 is equipped with two electric heating elements 21 (preferred: electric heaters 1700W, 230V). These are located in the water tank 7, just above the bottom of the water tank 7, preferably in the lower fifth above the bottom of the water tank 7 and are oriented horizontally, i.e. parallel to the bottom of the water tank 7. The heating elements 21 are enclosed as cladding tubes, preferably in welded-in stainless steel tubes, and are thereby insulated from the water.

The heating elements 21 are used to heat the water. The water temperature is monitored and controlled by means of a temperature sensor, preferably in the form of a thermostat (preferably 4-pole, e.g. fixed at 85° C., sensor in the water flow). Above the electric heating elements 21 there are preferably welded-in storage rails for receiving the immersion basket (not shown). By means of a pump 9, which draws off the water via an outlet opening 17 in the bottom area of the water tank 7 and flushes it again via water pipes 11 into an inlet opening 15 in the upper third of the water tank in the lateral area, the heat transfer medium water is kept in motion so that the energy used achieves its maximum efficiency in the shortest possible time. Draining of the water can also be carried out by means of the pump via a drain opening 13. For this purpose, the device can provide for the adjustment of a valve.

The water tank 7 is equipped with a lid 3 (preferred dimensions: width=36.5 cm, depth 27.0 cm, height 52 cm) made of double-walled, thermally insulated stainless steel sheet (2 cm thick) and seals tightly to the water tank 7 by means of a circumferential seal.

The lid 3 is attached to the top cover with two hinges and can be opened with the heat-insulated handle, up to an angle of approx. 135°, ensuring easy handling.

The control unit 19 of the device is preferably located in an installation box with a power contactor for the electrical heating elements 21, a time relay (with a fixed process time: preferably 45 min), three auxiliary contactors, a 16 ampere (A) automatic circuit breaker four fine-wire fuse holders with fine-wire fuses for the pump 9, various connection terminals and cables.

A thermostat (preferably fixed at 85° C.) for temperature control is preferably integrated in the water pipe or water conducting system 11.

An immersion basket (not shown) specially designed for the device 1 preferably comprises four, particularly preferably six or more compartments for one packaging unit each. The compartments of the immersion basket are preferably designed in such a way that each of the four, preferably six or more packaging units can be accommodated therein horizontally and layered one above the other. Accordingly, the immersion basket can be loaded with four, six or more packaging units according to the number of compartments and can be placed in the water tank 3 for regeneration.

An exemplary regeneration method is shown below:

On the day of regeneration of individual food components, the packaging units are heated to a desired temperature, preferably of at least 72° C., in the device 1. The preferred regeneration of the packaging units takes place in the following method steps.
1. Filling 17 liters of warm tap water into the water tank 7
2. Preheating of the water in the water tank 7 for approx. 45 minutes until a green LED control lamp is illuminated
3. Filling the immersion basket with the packing units
4. Loading the device 1 with the filled immersion basket
5. Closing the lid 3
6. Starting the warm-up (or reheating) program (approx. 40-45 min) by means of a button
7. Opening the lid 3 and removing the immersion basket
8. Filling the food components into a gastronomy (GN) container

An example decommissioning of the device is outlined below:
1. Hanging a drain hose attached to the drain opening 13 in a sink or placing it on a floor drain.
2. Opening the ball valve at the drain or discharge opening 13.
3. Setting the main switch to PUMP OFF.
4. When the water has run out, turn the main switch to OFF.
5. Closing the ball valve, stowing the hose on the hook at the rear of the unit.
6. Pulling out the main plug, visual inspection, stowing away
7. Cleaning the water tank 7 and housing 5
8. Leaving the lid 3 open to dry out

It is noted that various alternatives to the described embodiments of the invention may be used to carry out the invention and arrive at the solution according to the invention. Thus, the method according to the invention is not limited to the foregoing preferred embodiments. Rather, a large number of embodiments are conceivable, which may deviate from the solution presented. The aim of the claims is to define the scope of protection of the invention. The scope of protection of the claims is directed to covering the method according to the invention as well as equivalent embodiments thereof.

### REFERENCE

1 Device for heating packaging units
3 Lid
5 Housing
7 Water tank
9 Pump
11 Water pipes
13 Drain or discharge opening
15 Inlet opening
17 Outlet opening
19 Control unit
21 Electric heating elements

What is claimed is:

1. A method for preserving a hot prepared food component comprising the following steps
hot preparation of a quantity of the food component for a plurality of consumption portions,
filling of the hot-prepared food component at a temperature of at least 75° C. into a plurality of packaging units and subsequent sealing of the packaging units,
cooling the packaging units from a core temperature of at least 65° C. to a core temperature of less than 3° C. within 90 min or less,
characterized in that
the cooling of the packaging units takes place in a water bath, the temperature of which is 3° C. or less.

2. The method according to claim 1
characterized in that
at least two or more food components of a food menu are prepared, filled, and cooled.

3. The method according to claim 1
characterized in that
the hot preparation comprises heating the food component to the point of cooking.

4. The method according to claim 1
characterized in that
the amount of a prepared food component comprises a weight of more than 5 kg.

5. The method according to claim 1
characterized in that
the packaging units have a capacity of between 200 ml and 10 liters.

6. The method according to claim 1
characterized in that
the water bath for cooling the packaging units is equipped with one or more immersion baskets with compartments for the packaging units and a circulating cooler is connected to the water bath to ensure a temperature of 3° C. or less during cooling.

7. The method according to claim 1
characterized in that
the filling is carried out with the aid of an automatic thermoforming machine which carries
embossing of packaging units in tray form,
filling of the food components at a temperature of at least 75° C. into the packaging units,
steam rinsing of the packaging units with steam of a temperature of 100° C. or more,
sealing of the packaging units.

8. The method according to claim 1 additionally comprising
storage of the packaging units at a core temperature of 8° C. or less,
reheating the packaging units, from a core temperature of less than 8° C., to a core temperature of more than 65° C.

9. The method according to claim 8
characterized in that
the heating of the packaging units takes place in a period of 35 min to 55 min.

10. The method according to claim 9 characterized in that a device is used for heating the packaging units, comprising
a housing,
a water tank for holding water and a lid for closing the water tank (7),
an immersion basket with compartments for packaging units of refrigerated preserved food components to be placed in the water tank,
at least one electric heating element for heating the water,
a pump for circulating the water,
a control unit,
wherein the control unit is configured to regulate the power supply to the electric heating element during a reheating process such that the water temperature is maintained at a reheating temperature of 80°-90° C. for a predetermined reheating time.

11. The method according to claim 10
characterized in that
the reheating temperature for the device (1) is fixed and the device (1) does not provide for a possibility of changing or selecting the reheating temperature by a user.

12. The method according to claim 10
characterized in that
the device comprises a thermostat for a fixed setting of the reheating temperature, with a fixed temperature from a range between 80° C. and 90° C.

13. The method according to claim 10
characterized in that
the device comprises a temperature sensor for monitoring the water temperature.

14. The method according to claim 10
characterized in that
the reheating time is 35 min to 55 min and/or is fixedly set by means of a time relay.

15. The method according to claim 10
characterized in that
the compartments of the immersion basket are grid compartments and the immersion basket comprises between 2 and 10.

16. The method according to claim 10
characterized in that
the water tank exhibits a width of 30 to 40 cm, a depth of 20 to 30 cm and a height of 45 to 60 cm.

17. The method according to claim 10
characterized in that
the device comprises two heating elements, which are enclosed in cladding tubes and are present in the lower fifth of the water tank above the bottom of the water tank in a horizontally aligned manner, one or more storage rails being installed above the two heating elements for receiving the immersion basket.

18. The method according to claim 10
characterized in that
the water tank comprises an outlet opening in the bottom and comprises an inlet opening in an upper third, which are connected to one another via a water line and the pump, the pump being configured to draw the water out of the outlet opening in the bottom of the water tank and feed it into the inlet opening in the upper third of the water tank.

19. The method according to claim 10
characterized in that
the water tank has an outlet opening in the bottom and the housing has a discharge opening, which are connected to one another via a water line and the pump or can be connected in a valve position, the pump being configured to draw the water out of the outlet opening in the bottom of the water tank and to discharge the water via the discharge opening.

20. The method according to claim 10
characterized in that
the device comprises locking means for the lid (3) and the control unit (19) is configured to lock the lid (3) during the reheating process for the predetermined reheating time.
